(19) United States
(12) Patent Application Publication
(10) Pub. No.: US 2025/0266676 A1
(43) Pub. Date: Aug. 21, 2025

(54) PROTECTION ARRANGEMENT FOR A TRANSFORMER

(71) Applicant: Hitachi Energy Ltd, Zürich (CH)

(72) Inventors: Yash Thaker, Raleigh, NC (US); Imran Yousaf, Apex, NC (US); Abdelghafour Bouaicha, Apex, NC (US)

(21) Appl. No.: 19/105,092

(22) PCT Filed: Aug. 24, 2022
(86) PCT No.: PCT/EP2022/073631

§ 371 Date: Feb. 20, 2025

(51) Int. Cl. H02H 7/04; H02H 1/00

(52) U.S. Cl. CPC H02H 7/04; H02H 1/0007

(57) ABSTRACT

A protection arrangement for a transformer includes at least one fault interrupter configured to be coupled to at least one winding of the transformer, to protect the transformer from over-current faults, and a voltage protector configured to be coupled to the at least one winding, to protect the transformer from transient over-voltage events caused by the at least one fault interrupter.

### CROSS REFERENCE TO RELATED APPLICATIONS

This application is a 35 U.S.C. § 371 national stage application of PCT International Application No. PCT/EP2022/073631 filed on Aug. 24, 2022, the disclosures and content of which are incorporated by reference herein in their entireties.

### TECHNICAL FIELD

The embodiments described herein are generally directed to transformer assembly protection systems.

### BACKGROUND

In miniature distributor substation (“Mini Sub”) solution, a transformer and a fault interrupter are close coupled. Without suitable protection, voltage across windings at disconnection of an inductive load, interruption of load currents, interruption of short-circuit currents, any one or more at different and/or same time, is likely to exceed transformer basic insulation level (“BIL”) for certain conditions of breaker operation, putting the transformer at risk of premature failure. The interrupter cuts current before it reaches 0. The energy accumulated in the circuit may lead to multiple fast voltage transients observed along windings and across ground insulation. Breaking operation brings the most severe (duration, amplitudes) transients. The afore-mentioned close coupling exposes transformer active part to damage from transients, damaging a winding as well as insulation of a transformer arrangement.

### SUMMARY

Accordingly, an aspect of the disclosure involves a protection arrangement for a transformer that includes at least one fault interrupter configured to be coupled to at least one winding of the transformer, to protect the transformer from over-current faults, and a voltage protector configured to be coupled to the at least one winding, to protect the transformer from transient over-voltage events caused by the fault interrupter.

### BRIEF DESCRIPTION OF THE DRAWINGS

The details of the present disclosure, both as to its structure and operation, may be gleaned in part by study of the accompanying drawings, in which like reference numerals refer to like parts, and in which:

FIGS. 1A-B are simplified schematics of embodiments of a protection arrangement for a transformer;

FIG. 2 is a simplified schematic of an embodiment of a monitoring system of the protection arrangement for mainly monitoring the fault interrupter of FIGS. 1A-1B;

FIGS. 3A-B are side elevational views of embodiments of fault interrupters of the protection arrangement for a transformer of FIGS. 1A-1B;

FIG. 4 is a simplified schematic of a pair of fault interrupters of the protection arrangement for a transformer of FIGS. 1A-1B, in the case of a dual source; and

FIG. 5 is a simplified schematic of an embodiment of a voltage protector of the protection arrangement for a transformer of FIGS. 1A-1B.

### DETAILED DESCRIPTION

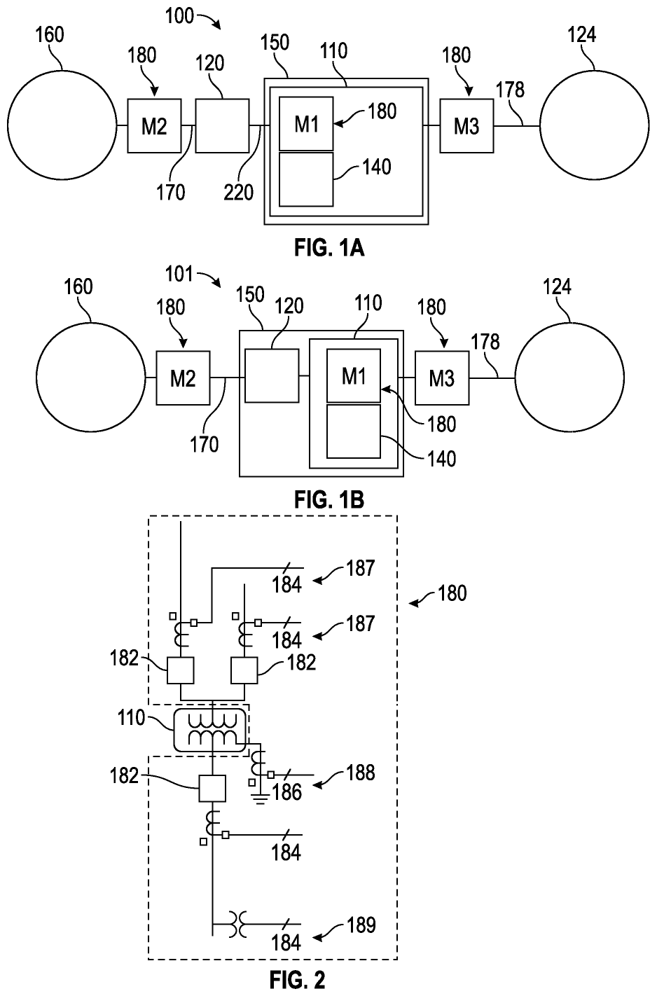

With reference to FIGS. 1A-B, embodiments of a protection arrangement 100, 101 for a transformer 110 will be described. The protection arrangement 100, 101 includes at least one fault interrupter 120 configured to be coupled to at least one (e.g., primary winding(s)) 130 of the transformer 110, to protect the transformer 110 from over-current faults, and a voltage protector 140 configured to be coupled to the at least one winding 130, to protect the transformer 110 from transient over-voltage events caused by the fault interrupter 120, as described further below and in greater detail in conjunction with FIG. 5. In one embodiment (not shown), the fault interrupter 120 and/or the voltage protector 140 are/is coupled to more than one winding 130, for example, but not by way of limitation, with a three-phase transformer. In another embodiment, the fault interrupter 120 and/or the voltage protector 140 are/is coupled to all windings 130. In a further embodiment (not shown), the fault interrupter 120 and/or the voltage protector 140 are/is coupled to a single winding 130, for example, but not by way of limitation, with a single-phase transformer. The transformer 110 identified in FIG. 1A is the active part (e.g., windings, core, internal connections) having the voltage protector 140.

In the event of current fault, over-voltage event, or combined current fault and over-voltage event, the protection arrangement 100, 101 will disconnect the transformer winding(s) 130. This reduces or eliminates damage to the transformer winding(s) 130 and insulation arrangement, and further reduces or eliminates the effect of additional forces that could come from an earth fault event or line fault event. The transformer 110 includes the primary winding 130 and a secondary winding (not shown). In one embodiment, the transformer 110 is a liquid-immersed (e.g., mineral oil, ester oil) transformer, but may also be a dry transformer. The transformer 110 may include a pad-mounted transformer, a ground-mounted transformer, a substation transformer, a Network transformer, or a Generator Step Up transformer. The active part of transformer 110 is enclosed within an enclosure (e.g., tank body) 150.

A source 160, such as a high-voltage side of an external network, supplies power to the transformer 110 via input cables 170. The transformed power is received by a load 124 via output cable(s) 178. The fault interrupter 120 may disconnect the transformer 110 from the source 160 at rated conditions or may be used to switch between sources.

One or more monitoring system(s) 180, located inside and/or outside of the transformer enclosure 150, monitors the protection arrangement 100, 101 everywhere. The monitoring system(s) 180 monitor one or more conditions in the protection arrangement 100, 101 to determine at least one of the over-current faults and the over-voltage events. In an embodiment, the monitoring system(s) 180 include at least a first monitoring system M1 located inside of the enclosure 150 housing the transformer 110 and a second monitoring system M2 located outside of the enclosure 150 housing the transformer 110. The monitoring system(s) 180 include one or more sensors and/or one or more relays. The monitoring system(s) 180 include one or more current transformers configured to measure both phase and ground current (e.g., measures primary current, secondary current, difference between two to determine if transformer 110 is operating properly) in the one or more lines, and/or one or more potential transformers that measure voltage in the one or more lines. A third monitoring system M3 is coupled to another winding (e.g., secondary winding). The monitoring system(s) 180 treats the fault interrupter 120 to have desired operation and signaling.

As shown in FIG. 2, an embodiment of the monitoring system 180 for mainly monitoring the fault interrupter 120 will be described. The monitoring system 180 includes auxiliary contacts 182 for signaling input, connector/disconnector switches 184, connector/disconnector switch 186, current transformers 187 for monitoring input, neural paths 188 each with a current transformer and grounding, and potential transformers 189 for monitoring input.

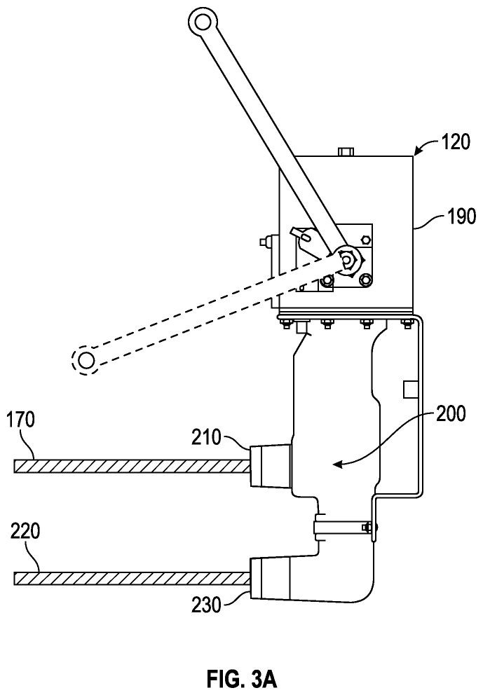

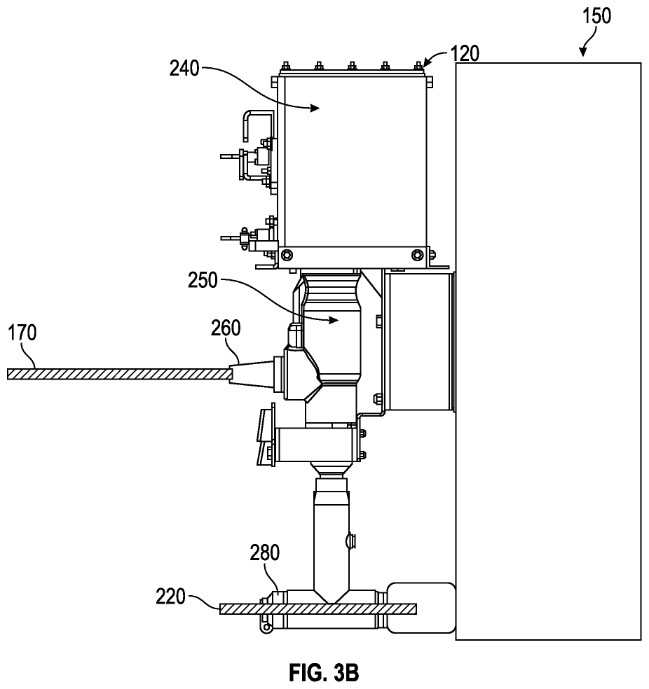

With reference to FIGS. 1A-B, and 3A-B, the fault interrupter 120 is coupled to the transformer 110 to protect the transformer 110 from over-current faults. For example, but not by way of limitation, the fault interrupter 120 is coupled to the transformer 110 by the fault interrupter 120 being connected to transformer bushings (directly in FIG. 3B, through cable in FIG. 3A) and the transformer bushings being connected with the winding(s)) 130 internally.

In one embodiment, the fault interrupter 120 is a medium-voltage fault interrupter 120. As used herein, “medium voltage” includes, for example, up to 36 kV. In another embodiment, the fault interrupter 120 is a high-voltage fault interrupter 120. As used herein, “high voltage” includes, for example, greater than 36 kV. In the embodiment shown, the fault interrupter 120 is externally mounted to the enclosure 150 of the transformer 110, but in an alternative embodiment of the protection arrangement 101, as shown in FIG. 1B, the fault interrupter 120 is internally mounted, inside the enclosure 150 of the transformer 110. The fault interrupter 120 includes an epoxy encapsulated fault interrupter switch with an integral magnetic actuator. Alternatively, the fault interrupter 120 may be spring-operated.

In the embodiment of the fault interrupter 120 shown in FIG. 3A, which is a flexible jumper connection between transformer bushing and fault interrupter 120, the fault interrupter 120 is a vacuum fault interrupter enclosed in a housing 190, outside of the enclosure 150 of the transformer 110. A vacuum bottle 200 is coupled to the housing 190. Input cable 170 is coupled to the vacuum bottle 200 via interface connection 210. Interconnection 220 is coupled to the vacuum bottle 200 via interface connection 230.

FIG. 3B illustrates another embodiment of the fault interrupter 120, which shows a direct connection between transformer bushing and fault interrupter 120 (no flexible jumper as in FIG. 3A) and where the fault interrupter 120 is a vacuum fault interrupter enclosed in a housing 240, outside of the enclosure 150 of the transformer 110. A vacuum bottle 250 is coupled to the housing 240. Input cable 170 is coupled to the vacuum bottle 250 via interface connection 260. Interconnection 220 is coupled to the vacuum bottle 250 via connection 280, which is a fault interrupter connection with the transformer bushing.

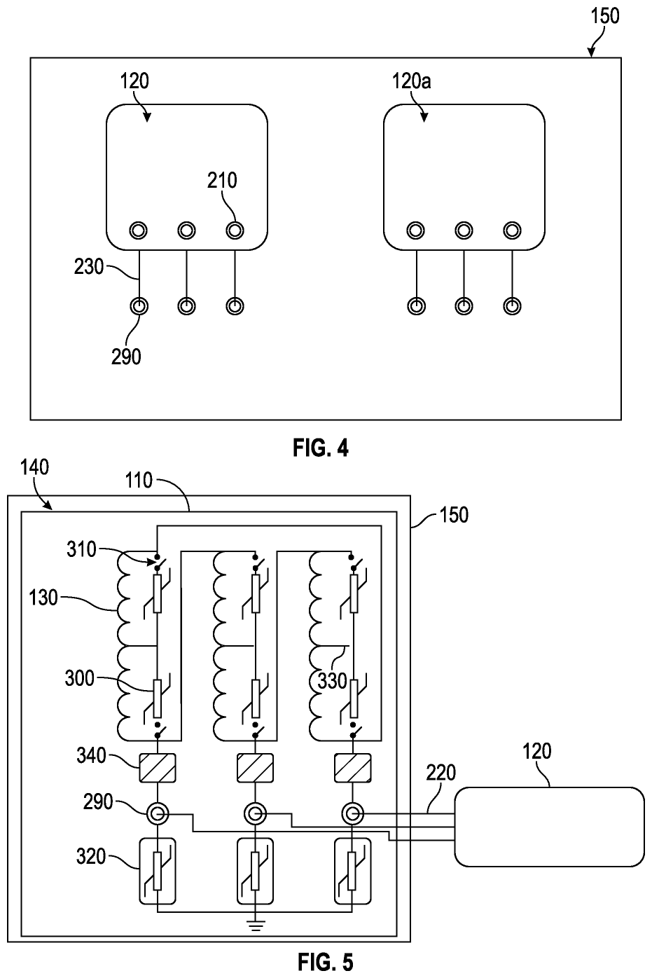

FIG. 4 illustrates another embodiment of the fault interrupter 120, where a second fault interrupter 120a is mounted externally to the enclosure 150 of the transformer 110 in the case of a dual/second source. Also shown in FIG. 4, interface connections 210, 230 and primary side transformer bushings 290 are provided.

With reference to FIG. 5, which shows the high-voltage side of the transformer 110, the voltage protector 140 will now be described in more detail. In the embodiment shown, the voltage protector 140, which is located inside the enclosure 150, is coupled to the primary winding 130 to protect the transformer 110 from transient over-voltage events caused by the fault interrupter 120. In alternative embodiments, the voltage protector 140 is located outside the enclosure 150 or located outside and inside the enclosure 150. In the embodiment shown in FIG. 5, The voltage protector 140 includes metal oxide (“MO”) varistors 300 and switches 310 integrated with the primary winding 130 along with surge arrestors 320 disposed between the primary side transformer bushings 290 in the enclosure 150 and ground.

The combination of the MO varistors 300 and switches 310 may provide a very efficient way to clamp the voltage along the primary winding 130 during transient over-voltage events to reduce or prevent damage to the transformer 110 and control transient over-voltages to a pre-defined limit, which depends on the transformer primary connected system voltage, the basic insulation level of the transformer insulation system, the power system configuration, and the combination of the components configured in power system, that is safe for the transformer 110. The surge arrestors 320 achieve combination of phase-to-phase and phase-to-ground protection of the transformer 110, but primarily provide phase-to-earth protection of the transformer 110. The MO varistors 300 and switches 310 are connected to the primary winding 130 at winding tap 330 to protect the primary winding 130. The MO varistors 300 primarily provide phase-to-phase protection of the transformer 110. Extra current protectors 340 such as, not limited to, fuses, surge counters, may be provided.

The protection arrangement 100, 101 for a transformer 110 is advantageous because with a higher number of switching operations, without a suitable protection, there is a higher risk of premature failure of transformer insulation due to uncontrolled switching transient over voltages Accordingly, it is essential to equip the transformer 110 (e.g., of a mini sub solution) with the voltage protector 140 to provide transient voltage protection.

The above description of the disclosed embodiments is provided to enable any person skilled in the art to make or use the subject matter. Various modifications to these embodiments will be readily apparent to those skilled in the art, and the general principles described herein can be applied to other embodiments without departing from the spirit or scope of the subject matter. Thus, it is to be understood that the description and drawings presented herein represent embodiments of the subject matter and are therefore representative of the subject matter which is broadly contemplated by the present subject matter. It is further understood that the scope of the present subject matter fully encompasses other embodiments that may become obvious to those skilled in the art and that the scope of the present subject matter is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1-18. (canceled)

19. A protection arrangement for a transformer, comprising:
at least one fault interrupter configured to be coupled to at least one winding of the transformer, to protect the transformer from over-current faults; and
a voltage protector configured to be coupled to the at least one winding, to protect the transformer from transient over-voltage events caused by the at least one fault interrupter,
wherein the voltage protector is configured to clamp the voltage along the at least one winding to reduce damage to the transformer.

20. The protection arrangement of claim 19, wherein the at least one fault interrupter is located outside of an enclosure housing the transformer.

21. The protection arrangement of claim 19, wherein the at least one fault interrupter is located inside of an enclosure housing the transformer.

22. The protection arrangement of claim 19, wherein the at least one fault interrupter includes a pair of fault interrupters configured to be coupled with a respective pair of sources.

23. The protection arrangement of claim 19, wherein the voltage protector is located inside of an enclosure housing the transformer.

24. The protection arrangement of claim 19, wherein the voltage protector includes at least one of metal oxide varistors and at least one of surge arresters as winding arresters.

25. The protection arrangement of claim 19, further comprising one or more monitoring systems to monitor one or more conditions in the protection arrangement to determine at least one of the over-current faults and the over-voltage events.

26. The protection arrangement according to claim 25, wherein the one or more monitoring systems include a first monitoring system located inside of an enclosure housing the transformer and a second monitoring system located outside of the enclosure housing the transformer.

27. The protection arrangement according to claim 25, wherein the one or more monitoring systems include one or more relays.

28. The protection arrangement according to claim 25, wherein the one or more monitoring systems include one or more sensors.

29. The protection arrangement according to claim 25, wherein the one or more monitoring systems is configured to monitor current to ground.

30. The protection arrangement according to claim 25, wherein the one or more monitoring systems is configured to monitor current from an external network to the protection arrangement.

31. The protection arrangement according to claim 25, wherein the protection arrangement includes one or more lines, and the one or more monitoring systems include one or more current transformers (CT) configured to measure current in the one or more lines.

32. The protection arrangement according to claim 25, wherein the protection arrangement transformer includes one or more lines, and the one or more monitoring systems include one or more potential transformers (PT) that measure voltage in the one or more lines.

33. The protection arrangement according to claim 25, wherein at least one of the one or more monitoring systems is coupled to another winding.

34. The protection arrangement of claim 19, wherein the transformer is a liquid-immersed transformer.

35. The protection arrangement of claim 19, wherein the transformer is a dry transformer.

36. The protection arrangement of claim 19, wherein the at least one fault interrupter is a medium-voltage interrupter.
